(19) United States
(12) Patent Application Publication
(10) Pub. No.: US 2025/0284112 A1
(43) Pub. Date: Sep. 11, 2025

(54) Device for Controlling Illumination for an Optical Instrument

(71) Applicant: KARL STORZ SE & Co. KG, Tuttlingen (DE)

(72) Inventor: Jan-Heiko Tischler, Schramberg (DE)

(73) Assignee: KARL STORZ SE & Co. KG, Tuttlingen (DE)

(21) Appl. No.: 19/076,459

(22) Filed: Mar. 11, 2025

(30) Foreign Application Priority Data
Mar. 11, 2024 (DE) 102024106941.4

(51) Int. Cl. G02B 23/24; H04N 23/50; H04N 23/695

(52) U.S. Cl. CPC G02B 23/2469; G02B 23/243; H04N 23/555; H04N 23/695

(57) ABSTRACT

A light control device for controlling the illumination direction for an optical instrument comprises a plurality of light transfer devices, with each light transfer device comprising a light entry surface and at least one light exit surface and being provided and designed to transfer illumination light from the light entry surface to the at least one light exit surface and with illumination light that was input coupled into the light entry surfaces exiting in different illumination directions through light exit surfaces of different light transfer devices; and a controllable input coupling device for controllably input coupling illumination light, which is created by a light source, into the light entry surface of at least one selectable light transfer device.

### CROSS REFERENCE TO RELATED APPLICATIONS

This application claims priority to German Patent Application No. 102024106941.4, filed Mar. 11, 2024, and entitled, “Lichtsteuerinrichtung zum Steuern von Beleuchtungslicht in einem optischen Instrument,” which is incorporated herein by reference.

### FIELD OF THE INVENTION

The present invention is directed to a light control device for controlling illumination light and to an endoscope, an exoscope or any other optical instrument for medical or technical purposes.

### BACKGROUND

Optical observation or viewing of an object requires illumination light that is reflected or scattered off the object. Illumination devices for illuminating observed objects are often integrated in optical instruments for applications in constricted conditions, especially in cavities. Such an illumination device may comprise one or more light sources that are integrated in the optical instrument and/or one or more light transfer devices. Light from a separate light source may be transferred to the optical instrument by means of a light guide cable and, within the optical instrument, to one or more light exit surfaces by means of one or more light transfer devices.

The higher the illumination light intensity, the more in-focus moving objects can be imaged, the sharper are the contrasts, and the more clearly colors can be distinguished. This is particularly relevant to significantly miniaturized objectives and image sensors, such as those used in some endoscopic procedures. Thus, illumination light that is as intensive as possible is desirable.

However, illumination light is also partially absorbed by each real beam path, i.e. each not perfectly transparent beam path, and by each real object, i.e. each object without ideal specular or diffuse reflection. Therefore, intensive illumination light always also heats the optical instrument and the observed object. By way of example, both of these effects may be detrimental to a patient in the case of a medical endoscope.

### BRIEF DESCRIPTION

With an endoscope or any other optical instrument with a changeable viewing direction, i.e. for example a changeable angle between viewing direction and longitudinal axis of the endoscope, and if no further measures are taken, some of the illumination light always illuminates objects or regions that cannot be observed. This wastes illumination light and is a particular source of danger because an approach of a non-observed object that, as a result, is particularly strongly heated at the same time may remain undetected. Therefore, the illumination direction should correspond to the viewing direction to the greatest possible extent at all times, and the currently captured field of view should be illuminated as uniformly and as brightly as possible while as little illumination light as possible should reach adjacent regions outside of the field of view.

Should illumination light created by various light sources be emitted into different

illumination and viewing directions, these light sources may be supplied with power in a manner dependent on the current viewing direction. This is not possible if, for example, the illumination light for all viewing directions is created by a single light source.

A problem addressed by the present invention is that of enabling improved illumination of an object observed by an optical instrument, in particular of increasing the intensity of illumination light within a field of view and/or reducing the waste heat created during the transmission of the illumination light.

A light control device for controlling the illumination direction for an optical instrument comprises a plurality of light transfer devices, with each light transfer device comprising a light entry surface and at least one light exit surface and being provided and designed to transfer illumination light from the light entry surface to the at least one light exit surface and with illumination light that was input coupled into the light entry surfaces exiting in different illumination directions through light exit surfaces of different light transfer devices; and a controllable input coupling device for controllably input coupling illumination light, which is created by a light source, into the light entry surface of at least one selectable light transfer device.

The light source may comprise one or more light-emitting diodes or lasers or high-pressure gas discharge lamps or other individual light sources. The light fluxes created by different light sources are not varied within the scope of controlling the input coupling of illumination light. Instead, the illumination light created by a light source is input coupled into different light transfer devices by the controllable input coupling device.

The light source may be integrated with the optical instrument in which the light control device is integrated or for which the light control device is provided. In an alternative, the predetermined light source may be a piece of an apparatus that is separate from the optical instrument, mechanically and optically separable from said optical instrument and couplable with said optical instrument by means of a light guide cable.

The light control device is provided and designed in particular for integration in an endoscope or an exoscope or a microscope with a changeable viewing direction for medical or nonmedical purposes. In an alternative, the light control device may be part of such an endoscope or exoscope or microscope, in particular integrated therein.

The field of view of an optical instrument is the region within which all objects are optically captured, i.e. imaged. All objects within the field of view are captured, for example rendered visible through an eyepiece or imaged on a read region of an image sensor. All objects outside of the field of view are not captured, i.e. are for example not visible through an eyepiece of the optical instrument or not imaged on an image sensor or not imaged on a read region of the image sensor.

The viewing direction is the direction from the optical instrument or from the distal end of the optical instrument to a faraway object located in the center of the image-side field of view, i.e. imaged into the center of a (not yet rectified) image captured by means of the optical instrument. An optical instrument has a changeable viewing direction if the viewing direction of the optical instrument at rest, i.e. said optical instrument is neither moved translationally nor pivoted or rotated about any axis, is changeable, in particular pivotable. For example, the angle between the viewing direction and a longitudinal axis of the shaft of the optical instrument is changeable.

An optical instrument with a changeable viewing direction for example comprises a pivotable mirror, a pivotable prism or a pivotable camera. In particular, the pivotable mirror, the pivotable prism or the pivotable camera is pivotable relative to the otherwise stationary optical instrument. The pivotable mirror, the pivotable prism or the pivotable camera is arranged in particular at a distal end of the optical instrument, for example at the distal end of an endoscope. Alternatively, an optical instrument with a changeable viewing direction may for example comprise a stationary objective with a very broad field of view, with only a portion of the real image created by the objective being captured at any one time. For example, only a portion of an image sensor capturing the entire real image is read at any one time, with this portion being displaceable. Alternatively, an image sensor capturing only a portion of the real image at any one time may for example be moved laterally in order to move the viewing direction.

Each of the light transfer devices in particular comprises one or more optical fibers or one or more bundles or partial bundles of in each case a plurality of optical fibers. Illumination light input coupled into the light entry surface of a first light transfer device is transmitted into a first illumination direction through the light exit surface of the first light transfer device. Illumination light input coupled into the light entry surface of a second light transfer device is transmitted into a second illumination direction through the light exit surface of the second light transfer device, with the second illumination direction differing from the first illumination direction. Should the first light transfer device and/or the second light transfer device each comprise a plurality of light exit surfaces through which illumination light is transmitted into different illumination directions, the light illumination directions of the first light transfer device differ at least in part from the illumination directions of the second light transfer device.

In particular, the controllable input coupling device comprises at least a translatable, pivotable, rotatable or otherwise movable piece. The controllable input coupling device may be inherently stiff or flexible. The controllable input coupling device or a piece of the same is in particular moved in such a way that the field of view is largely or fully illuminated at all times and significantly less illumination light or as little illumination light as possible is incident on objects outside of the field of view. To this end, the controllable input coupling device is in particular directly or indirectly connected to a pivotable mirror, a pivotable prism or a pivotable camera in such a mechanical, magnetic or other manner that both parts are moved synchronously at least in regions. For example, the controllable input couple device may comprise a pivotable or translatable light source and/or a pivotable mirror and/or a non-rotationally symmetric but rotatable fiber cone and/or a flexible light guide.

The light control device may improve the ratio of light flux of the illumination light within the field of view to the overall light power of the light source by virtue of less illumination light being transmitted outside of the field of view at all times. For example, in the event of the same overall light power, the light control device may increase the light flux of the illumination light within the field of view or enable the same light flux within the field of view with a lower overall light power.

A light control device as described herein comprises, in particular, a drive device for moving at least one piece of the controllable input coupling device.

In particular, the drive device is provided and designed to translationally move, pivot, rotate or otherwise move a translatable, pivotable, rotatable or otherwise movable piece of the controllable input coupling device. Alternatively, the drive device may be provided and designed to translationally move, pivot, rotate or otherwise move the entire controllable input coupling device.

In particular, the drive device is provided and designed to move a light source or a mirror or any other reflective surface and/or deform a flexible light guide.

In a light control device as described herein, the drive device comprises in particular an actuation device which is directly manually actuatable, directly or indirectly coupled in mechanical or magnetic fashion with the controllable input coupling device.

The actuation device is provided and designed, in particular simultaneously, to pivot the viewing direction.

The actuation device is arranged in particular at a proximal end region of the optical instrument, for example at a handling device for manual handling. The actuation device for example comprises a manually rotatable wheel, a manually pivotable lever, a manually pivotable rocker, a manually displaceable element, a manually pressable pushbutton.

The actuation device may be directly or indirectly mechanically coupled with the input coupling device, for example by friction wheels, gearing, a rack, a drawbar or push bar, a Bowden cable, a control cable, hydraulically, pneumatically or magnetically. In the case of magnetic coupling, for example, a plurality of first magnets with alternating polarity are arranged in or on a manually rotatable wheel outside of a hermetically sealed cover of the optical instrument and a plurality of corresponding second magnets are arranged within the hermetically sealed cover, with the second magnets being mechanically connected or coupled to the input coupling device.

In the case of a light control device as described herein, the drive device comprises an electric motor in particular.

The electric motor is provided and designed for pivoting the viewing direction at the same time, in particular.

The electric motor can be a rotating electric motor with a stator and a rotor that rotates or pivots during the intended use, or a linear motor. The electric motor may be connected to the input coupling device directly or via a gear-in particular a reduction gear. A controller may supply electric power to the electric motor, in particular in a manner dependent on an input by a person on a user interface.

In the case of a light control device as described herein, the controllable input coupling device comprises in particular a light guide device having a light entry surface and a light exit surface, with at least the light guide device or the light entry surface of the light guide device or the light exit surface of the light guide device or the light entry surface of at least one light transfer device being translatable or rotatable or pivotable in such a way that the light exit surface of the light guide device is arranged vis-à-vis the light entry surface of at least one selectable light transfer device or rests against said light entry surface.

The light guide device is flexible in particular. For example, in this context the light entry surface of the light guide device is permanently and stationarily arranged vis-à-vis a light source or in a coupling for coupling the optical instrument with a light guide cable, while the light exit surface is translationally movable or pivotable in order to be arranged vis-à-vis the stationary light entry surface or surfaces of one or more selectable light transfer devices.

Alternatively, the light exit surface of the light guide device is for example also stationary, while the light entry surfaces of the light transfer devices are movable relative to the light exit surface of the light guide device.

In the case of a light control device as described herein, the controllable input coupling device comprises in particular a fiber cone having a light entry surface and a light exit surface, with at least the fiber cone or the light entry surface of at least one light transfer device being rotatable or pivotable in such a way that the light exit surface of the fiber cone is arranged vis-à-vis the light entry surface of at least one selectable light transfer device or rests against said light entry surface.

A fiber cone-often also referred to as a fiber taper or taper-is an optical component that for example enables low-loss input coupling of light from a first light guide with a first, larger diameter into a second light guide with a second, smaller diameter. A fiber cone is a constituent part of many endoscopes and other optical instruments and is arranged in a light coupling in particular. The light exit surface of a light guide cable mechanically and optically connected to the light coupling is often arranged at a small distance immediately vis-à-vis the light entry surface of the fiber cone or rests against said light entrance surface.

Simultaneously designing the fiber cone as an input coupling device or as a piece of the input coupling device may simplify the structure of the optical instrument and reduce the necessary installation space.

In a light control device as described herein, the fiber cone is rotatable in particular about an axis of rotation orthogonal to the light entry surface of the fiber cone, with the light exit surface of the fiber cone not being symmetrical with respect to the axis of rotation.

In this case, the light entry surface of the fiber cone is rotationally symmetrical with respect to the axis of rotation in particular. As a result, a rotation of the fiber cone about the axis of rotation does not change the light flux input coupled into the fiber cone. The asymmetric arrangement or embodiment of the light exit surface of the fiber cone with respect to the axis of rotation enables controllable input coupling of illumination light, which passes through the fiber cone, into the light entry surfaces of various light transfer devices. To this end, the light entry surfaces or their surface centers are arranged on a circular arc in particular.

In the case of a light control device as described herein, the controllable input coupling device is provided and designed in particular to at least translationally move or pivot or rotate a light source.

As a result of the translational movement or pivot or rotation, the illumination light created by the light source can be directed at various light entry surfaces and hence be input coupled into various light transfer devices.

An optical instrument comprises a light control device as described herein.

In particular, the optical instrument is an endoscope, an exoscope or a microscope for medical or nonmedical applications.

An optical instrument as described herein in particular furthermore comprises a proximal end region, at which the optical instrument can be fastened or manually guided during intended use; and a distal end region, at which the light exit surfaces of the light transfer devices of the light control device are arranged, with the controllable input coupling device being arranged in the proximal end region of the optical instrument.

The optical instrument may be an endoscope, exoscope, or other optical device.

The proximal end region of the optical instrument comprises a handling device in particular or is formed by a handling device.

The distal end region of the optical instrument comprises a distal end region of a shaft of the optical instrument in particular or is formed by the distal end region of the shaft.

An optical instrument as described herein in particular furthermore comprises a controllable viewing direction device for controlling the viewing direction (a, b, d) of the optical instrument, with the controllable input coupling device being coupled with the controllable viewing direction device.

The controllable viewing direction device and the controllable input coupling device are mechanically coupled to one another in particular, for example by means of a gear, a Bowden cable, a drawbar or push bar, a pull cable or any other way.

An optical instrument as described herein in particular furthermore comprises a light coupling situated at the proximal end region of the optical instrument and serving for mechanical and optical coupling of a light guide cable with the optical instrument, with the controllable input coupling device being arranged on or in the light coupling.

For example, the light coupling comprises lugs for a bayonet joint (often also referred to as a bayonet connection) or a male thread for detachable mechanical connection with a union nut at an end of the light guide cable.

Especially if the controllable input coupling device comprises a rotatable fiber cone, the at least partial arrangement thereof in the light coupling may reduce the number of component parts and save installation space.

### BRIEF DESCRIPTION OF THE DRAWINGS

Embodiments are described in detail below with respect to the attached drawings described below.

FIG. 1 shows a schematic illustration of an optical instrument.

FIG. 2 shows a schematic illustration of a section through an optical instrument with a light control device.

FIG. 3 shows a schematic illustration of an arrangement of light entry surfaces of light transfer devices.

FIG. 4 shows a schematic illustration of a further arrangement of light entry surfaces of light transfer devices.

FIG. 5 shows a schematic illustration of a further arrangement of light entry surfaces of light transfer devices.

FIG. 6 shows a schematic illustration of a section through a further optical instrument with a light control device.

FIG. 7 shows a schematic illustration of a further arrangement of light entry surfaces of light transfer devices.

FIG. 8 shows a schematic illustration of a further arrangement of light entry surfaces of light transfer devices.

FIG. 9 shows a schematic illustration of a section through a further optical instrument with a light control device.

FIG. 10 shows a schematic illustration of a section through a further optical instrument with a light control device.

### DETAILED DESCRIPTION OF THE VARIOUS EMBODIMENTS

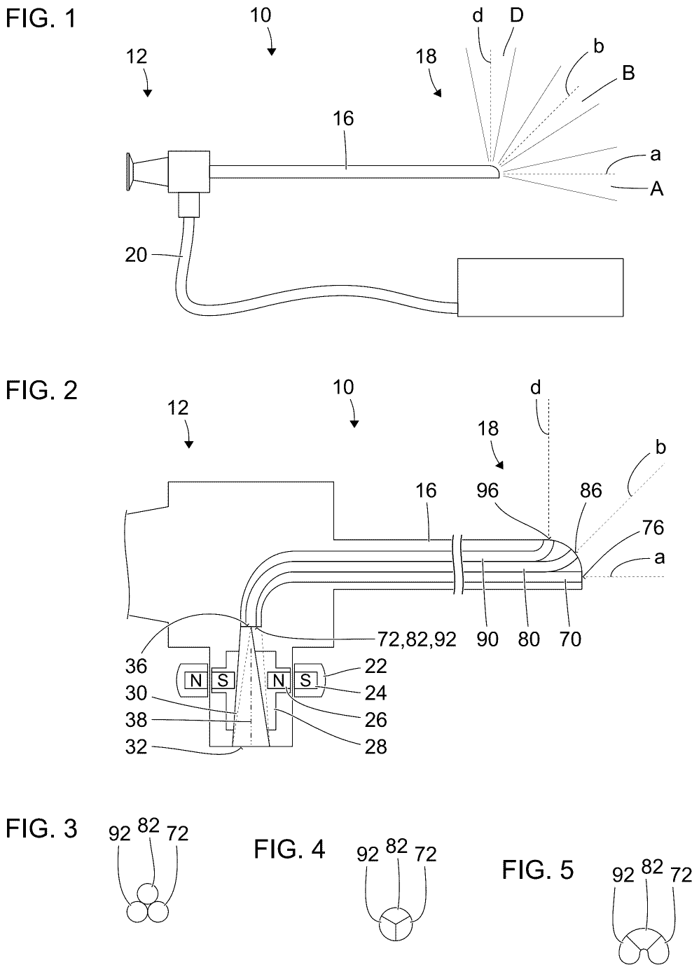

FIG. 1 shows a schematic illustration of an optical instrument 10, specifically an endoscope. The endoscope 10 comprises a proximal end region 12 with an eyepiece that creates a virtual image. The virtual image created by the eyepiece may be captured by means of a camera or directly by means of the human eye. Furthermore, a light coupling 14 is provided at the proximal end region 12 of the endoscope 10.

The endoscope 10 furthermore comprises a shaft 16, the distal end region of which forms the distal end region 18 of the endoscope 10. A viewing direction device (not depicted in FIG. 1) for varying the viewing direction of the endoscope 10 is provided in the distal end region 18 of the endoscope 10 and of the shaft 16 thereof. For example, the viewing direction device comprises a pivotable camera or a pivotable reflective interface or layer. For example, the reflective interface or layer is provided on a pivotable prism. The angle between the viewing direction and the longitudinal axis of the shaft 14 may be modified by pivoting the camera or the reflective interface or layer. By way of example, FIG. 1 depicts three viewing directions a, b, d and three associated fields of view A, B, D.

In the configuration depicted in FIG. 1, the light coupling 14 is connected by a light guide cable 20 to an external light source. Illumination light created by the external light source is transmitted through the light guide cable 20 to the proximal end region 12 of the endoscope 10 and, in the endoscope 10, through one or more light transfer devices to the distal end region 18 of the endoscope 10. At the distal end region 18 of the endoscope 10, the illumination light emerges and illuminates an object observed by means of the endoscope 10.

The endoscope comprises one of the light control devices illustrated below in FIGS. 2 to 9, the light control device controlling the illumination direction such that the illumination light predominantly or largely emerges only in the current viewing direction a, b, d and illuminates the current field of view A, B, D.

FIG. 2 shows a schematic and enlarged illustration of a section through an embodiment of the endoscope 10 illustrated in FIG. 1. The sectional plane of FIG. 2 is parallel to the plane of the drawing of FIG. 1. The shaft 16 of the endoscope 10 is illustrated with a shortened length. The proximal end region 12 of the endoscope 10, specifically the eyepiece there, has also been illustrated with a shortened length.

The endoscope 10 comprises a handwheel 22, which is rotatable about the light coupling 14 in the example illustrated. The handwheel 22 is arranged outside a hermetically sealed cover of the endoscope 10. The handwheel 22 comprises a plurality of magnets 24, the poles of which located on the inner side of the handwheel 22 being north and south poles that alternate in the direction of the circumference.

Magnets 26 are provided on a mounting 28 within the hermetically sealed cover of the endoscope 10. The radially outwardly pointing ends of the magnets 26 on the mounting 28 are also north and south poles that alternate in the direction of the circumference. The north poles of the magnets 24 on the handwheel 22 attract the south poles of the magnets 26 on the mounting 28; the south poles of the magnets 24 on the handwheel 22 attract the north poles of the magnets 26 on the mounting 28. A rotation of the handwheel 22 is therefore accompanied by a rotation of the mounting 28.

The mounting 28 holds a fiber cone 30 with a light entry surface 32 and a light exit surface 36.

As indicated in FIG. 2, the light entry surface 32 of the fiber cone 30 may be arranged such that it can be directly optically coupled with a light exit surface of a light guide cable 20 (cf. FIG. 1) connected to the light coupling 14. In this case, the light entry surface 32 of the fiber cone 30 rests directly against the light exit surface of the light guide cable 20. Alternatively, the light exit surface of a light guide cable 20 may be arranged at a small distance vis-à-vis the light entry surface 32 of the fiber cone 30 during the intended use. In particular, shape and size of the light entry surface 32 of the fiber cone 30 are matched to the shape and size of the light exit surface of a light guide cable 20, for which the endoscope 10 is provided.

Deviating from the illustration in FIG. 2, a coverslip, for example, may form the outer surface of the endoscope 10 in the region of the light entry surface 32 of the fiber cone 30.

The light exit surface 36 is smaller than the light entry surface 32. The fiber cone 30 is rotatable about an axis of rotation 38. The axis of rotation 38 of the fiber cone 38 is parallel to the plane of the drawing of FIG. 2. The light entry surface 32 of the fiber cone 30 is orthogonal to the plane of the drawing of FIG. 2 and orthogonal and rotationally symmetrical with respect to the axis of rotation 38. The light exit surface 36 of the fiber cone 30 is orthogonal to the plane of the drawing of FIG. 2 and orthogonal but not rotationally symmetrical with respect to the axis of rotation 38.

The endoscope 10 furthermore comprises a plurality of light transfer devices 70, 80, 90 which extend within the endoscope, especially within the shaft 16, from the proximal end region 12 to the distal end region 18 of the endoscope 10. Each light transfer device 70, 80, 90 comprises a light entry surface 72, 82, 92 and one or more light exit surfaces 76, 86, 96. Each light transfer device 70, 80, 90 comprises an optical fiber or an optical waveguide or a bundle of optical fibers or optical waveguides which, at least in the vicinity of the distal end, may be divided or fanned into a plurality of partial bundles with a light exit surface in each case.

The light entry surfaces 72, 82, 92 of the light transfer devices 70, 80, 90 are arranged next to one another in a plane in the proximal end region 12 of the endoscope 10. The plane in which the light entry surfaces 72, 82, 92 of the light transfer devices 70, 80, 90 are located is in particular parallel to the light exit surface 36 of the fiber cone 30. The plane in which the light entry surfaces 72, 82, 92 of the light transfer devices 70, 80, 90 are located is at a small distance from the light exit surface 36 of the fiber cone 30. Alternatively, the light exit surface 36 of the fiber cone 30 rests against one or more light entry surfaces 72, 82, 92 of the light transfer devices 70, 80, 90.

The light exit surface 36 of the fiber cone is smaller than the light entry surfaces 72, 82, 92 of the light transfer devices 70, 80, 90. Therefore, illumination light emerging from the light exit surface 36 of the fiber cone 30 is exclusively or predominantly input coupled into some of the light transfer devices 70, 80, 90 at all times, while no illumination light or only substantially less illumination light is input coupled into one or more light transfer devices 70, 80, 90.

The light entry surfaces 72, 82, 92 of the light transfer devices 70, 80, 90 are arranged such that rotation of the fiber cone 30 about the axis of rotation 38 renders various positions selectable, in which illumination light should be input coupled into light transfer devices 70, 80, 90. Two possible arrangements of the light entry surfaces 72, 82, 92 of the light transfer devices 70, 80, 90 are illustrated below in FIG. 3.

The optical fibers or optical waveguides that form the light transfer devices 70, 80, 90 are oriented differently in the vicinity of the light exit surfaces 76, 86, 96 of the light transfer devices 70, 80, 90. The light exit surfaces 76, 86, 96 of the light transfer devices 70, 80, 90 are also oriented differently. Therefore, illumination light emerges in different directions from different light exit surfaces 76, 86, 96. By way of example, illumination light emerges from the light exit surface 76 of the light transfer device 70 in the viewing direction a, illumination light emerges from the light exit surface 86 of the light transfer device 80 in the viewing direction b, and illumination light emerges from the light exit surface 96 of the light transfer device 90 in the viewing direction d. In this case, the intensity is always a continuous function of the angle, and so the illumination light for example has the greatest intensity in a certain direction a, b, d but is also transmitted into adjacent directions with reducing intensity.

The handwheel 22 is an actuation device; together with the magnets 24, 26 and the mounting 28, it forms a drive device for moving, specifically rotating, the fiber cone 30. The fiber cone 30 is a movable light guide device and forms an input coupling device for input coupling illumination light into the light entry surface 72, 82, 92 of at least one selectable light transfer device 70, 80, 90.

By rotating the handwheel 22, the fiber cone 30 can be rotated about its axis of rotation 38, and the light transfer device or light transfer devices 70, 80, 90, into which the illumination light is input coupled or predominantly input coupled, and hence the direction a, b, d, into which the illumination light is steered or predominantly steered, can be selected.

The handwheel 22 serves, in particular at the same time, for manual control of the viewing direction, for example by tilting a prism or a camera in the distal end region 18 of the endoscope 10. Deviating from the illustration in FIG. 2, the handwheel 22 may be arranged at a different location, for example arranged in a manner enclosing the shaft 16 or the tube surrounding the eyepiece or at a different location.

Alternatively, a different manual user interface or device for manually moving the fiber cone 30 and a viewing direction device may be provided, for example a lever, a pushbutton, a rocker. Alternatively, an electric motor for example may be provided in order to move the fiber cone 30. Optionally and in a manner deviating from the illustration in FIG. 2, the handwheel, the lever, the pushbutton, the rocker or the other manual user interface or the electric motor may be coupled to the fiber cone by way of a gear.

FIG. 3 shows a schematic illustration of the light entry surfaces 72, 82, 92 of the light transfer devices 70, 80, 90 depicted in FIG. 2. The plane of the drawing in FIG. 3 is orthogonal to the plane of the drawing of FIGS. 1 and 2 and orthogonal to the axis of rotation 38 of the fiber cone 30.

In the example shown in FIG. 3, each individual light entry surface 72, 82, 92 is circular, and the diameters of all light entry surfaces 72, 82, 92 are the same. The light entry surfaces 72, 82, 92 are arranged as nearest neighbors to one another, i.e. they are in contact with one another or are only separated from one another by structurally required components such as tubelike or pipelike covers.

Insofar, the embodiment of FIG. 3 is easily representable as a light transfer device made of a bundle of optical fibers or optical waveguides is particularly easily configurable with a circular cross section. A disadvantage of the embodiment of FIG. 3 is that, depending on the position of the fiber cone 30 and its light exit surface 36 (cf. FIG. 2), some of the illumination light reaches interspaces between the light entry surfaces 72, 82, 92. This portion of the illumination light is not transmitted to the distal end region 18 of the endoscope 10, i.e. does not contribute to the illumination of an observed object, but instead heats the proximal ends of the light transfer devices 70, 80, 90.

FIG. 4 shows a schematic illustration of the light entry surfaces 72, 82, 92 in another embodiment. The type of illustration, in particular the pose of the plane of the drawing, corresponds to that of FIG. 3.

In the example shown in FIG. 4, each individual light entry surface 72, 82, 92 has the shape of a circular segment with two straight edge portions and a circular arc-shaped edge portion. The light entry surfaces 72, 82, 92 are arranged such that together they form a circular area.

No interspaces between the light entry surfaces 72, 82, 92 are present in the idealized embodiment shown in FIG. 4. However, only small interspaces between the light entry surfaces 72, 82, 92 are also realizable in a similar real embodiment that can be obtained with comparatively little technical outlay. Hence, less illumination light is lost in comparison with the embodiment illustrated in of FIG. 3, and the proximal ends of the light transfer devices 70, 80, 90 and the surroundings thereof are heated less.

FIG. 5 shows a schematic illustration of the light entry surfaces 72, 82, 92 in a further embodiment. The type of illustration, in particular the pose of the plane of the drawing, corresponds to that of FIGS. 3 and 4.

In the example shown in FIG. 5, each individual light entry surface 72, 82, 92 has straight and circular arc-shaped edge portions. The light entry surfaces 72, 82, 92 adjoin one another with their straight edge portions and together form a circular arc segment with rounded-off ends.

No interspaces between the light entry surfaces 72, 82, 92 are present in the idealized embodiment shown in FIG. 5. However, only small interspaces between the light entry surfaces 72, 82, 92 are also realizable in a similar real embodiment that can be obtained with comparatively little technical outlay. Hence, less illumination light is lost in comparison with the embodiment illustrated in FIG. 3, and the proximal ends of the light transfer devices 70, 80, 90 and the surroundings thereof are heated less.

While the asymmetric fiber cone 30 is rotated through approx. 240 degrees to successively steer the illumination light in directions a, b, d (cf. FIG. 2) in the embodiments of the light entry surfaces 72, 82, 92 depicted in of FIGS. 3 and 4, an angle of approx. 180 degrees is sufficient in the example shown in FIG. 5. The circular arc formed by the light entry surfaces 72, 82, 92 may be shorter or longer than shown in FIG. 5. Accordingly, the angle of rotation of the asymmetric fiber cone 30 between steering the illumination light in direction a and steering the illumination light in direction d may be greater than or less than 180 degrees.

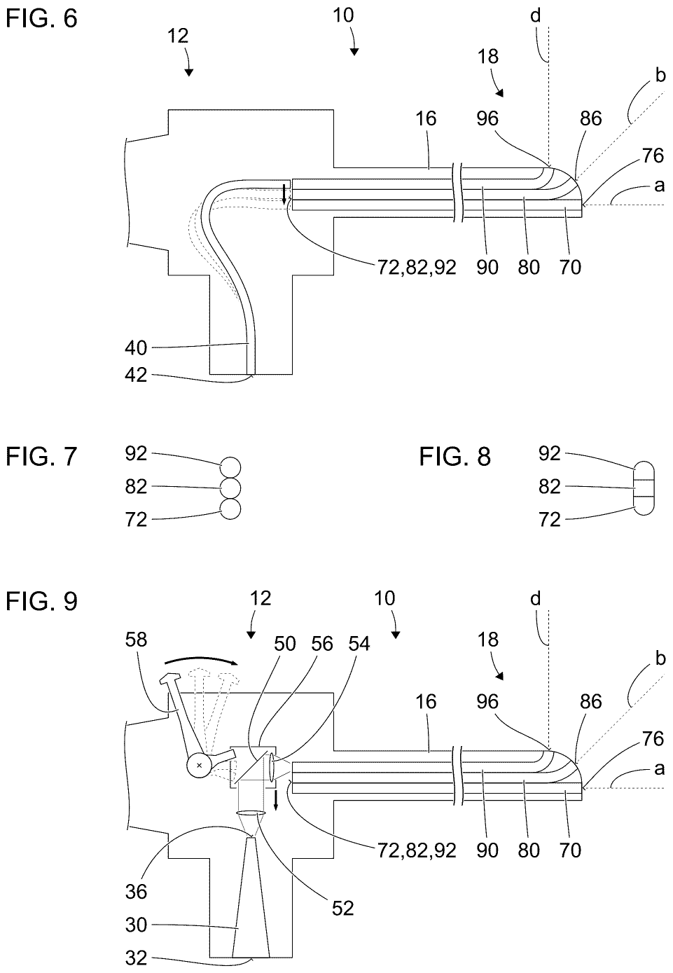

FIG. 6 shows a schematic illustration of a section through a further embodiment of the endoscope 10 from FIG. 1, which in terms of a few features, properties and functions is similar to the embodiment illustrated on the basis of FIG. 2. The type of illustration, the pose and the orientation of the plane of the drawing correspond to those in FIG. 2. In particular, features, properties, and functions whereby the embodiment shown in FIG. 6 differs from the embodiment illustrated in FIG. 2 are described below.

Like in the embodiment depicted in FIG. 2, the light entry surfaces 72, 82, 92 of the light transfer devices 70, 80, 90 are arranged next to one another in a plane. In the depicted example, the orientation of this plane differs to that of the embodiment depicted in FIG. 2.

In particular, the embodiment of the endoscope 10 shown in FIG. 6 differs from the embodiment illustrated in FIG. 2 in that a non-rotatable but flexible light guide device 40 is provided in the proximal end region 12 of the endoscope in place of a rotatable but non-rotationally symmetrical fiber cone. The flexible light guide device 40 comprises a light entry surface 42 and a movable light exit surface 46. In particular, the flexible light guide device 40 consists of a bundle of optical fibers or optical waveguides and may in this respect be similar to the light transfer devices 70, 80, 90.

As indicated in FIG. 6, the light entry surface 42 of the flexible light guide device 40 may be arranged such that it can be directly optically coupled with a light exit surface of a light guide cable 20 (cf. FIG. 1) connected to the light coupling 14. In this case, the light entry surface 42 of the flexible light guide device 40 rests directly against the light exit surface of the light guide cable 20. Alternatively, the light exit surface of a light guide cable 20 may be arranged at a small distance vis-à-vis the light entry surface 42 of the flexible light guide device 40 during the intended use.

Deviating from the illustration in FIG. 6, a coverslip, for example, may form the outer surface of the endoscope 10 in the region of the light entry surface 42 of the flexible light guide device 40. Deviating from the illustration in FIG. 6, a fiber cone which optically couples a light guide cable 20 connected to the light coupling 14 with the flexible light guide device 20 may be provided as an alternative to a cover slip or in addition to that. The fiber cone and the flexible light guide device 40 may be integrated in a component part.

In contrast to the light entry surface 42 of the flexible light guide device 40, the light exit surface 46 of the flexible light guide device 40 may be moved translationally, as indicated in FIG. 6 by an arrow. As a result, the light exit surface 46 of the flexible light guide device 40 may alternatively be arranged vis-à-vis one or more of the light entry surfaces 72, 82, 92 of the light transfer devices 70, 80, 90 or, deviating from the illustration in FIG. 6, rest against said light entry surfaces.

A drive device for moving the light exit surface is not depicted in FIG. 6. Similar to what was depicted in FIG. 2, a handwheel, a lever, a push button, a rocker or any other manually movable component part as mechanical user interface may be provided as drive device for moving the light exit surface 46 of the flexible light guide device 40. Alternatively, an electric motor for example may be provided as drive device. The drive device may be mechanically coupled to the flexible light guide device 40 directly or indirectly, for example by means of a gear.

The flexible light guide device forms an input coupling device for input coupling illumination light into the light entry surface 72, 82, 92 of at least one selectable light transfer device 70, 80, 90. By positioning the light exit surface 46, the light transfer device or light transfer devices 70, 80, 90, into which the illumination light is input coupled or predominantly input coupled, and hence the direction a, b, d, into which the illumination light is steered or predominantly steered, can be selected.

In FIG. 6, solid lines are used to depict the flexible light guide device 40 in a position in which the illumination light is exclusively or predominantly input coupled into the light transfer device 90 and transmitted into the direction d. Dashed lines are used to depict positions and configurations of the flexible light guide device 40, in which the illumination light is input coupled into the light transfer devices 80 and 70 and transmitted into the direction b and a, respectively.

FIG. 7 shows a schematic illustration of the light entry surfaces 72, 82, 92 of the light transfer devices 70, 80, 90 depicted in FIG. 6. The plane of the drawing in FIG. 7 is orthogonal to the planes of the drawings of FIGS. 1 and 6 and orthogonal to the longitudinal axis of the shaft 16 of the endoscope 10 (cf. FIG. 1).

Similar to the example depicted in FIG. 3, each individual light entry surface 72, 82, 92 is also circular in the example shown in FIG. 7, and the diameters of all light entry surfaces 72, 82, 92 are the same. The light entry surfaces 72, 82, 92 are arranged as nearest neighbors to one another, i.e. they are in contact with one another or are only separated from one another by structurally required components such as tubelike or pipelike covers. Unlike the example depicted in FIG. 3, the light entry surfaces 72, 82, 92 are arranged in a row.

Similar to the example depicted in FIG. 3, the example shown in FIG. 7 is also easily producible but has the disadvantage that, depending on the position of the light exit surface 46 of the flexible light guide device 40, some of the illumination light is not input coupled into a light transfer device 70, 80, 90. The illumination light not input coupled does not contribute to the illumination of an observed object but instead heats the surroundings of the proximal ends of the light transfer devices 70, 80, 90.

FIG. 8 shows a schematic illustration of the light entry surfaces 72, 82, 92 in another embodiment. The type of illustration, in particular the pose of the plane of the drawing, corresponds to that of FIG. 7.

In the example shown in FIG. 8, the light entry surfaces 72, 92 found at the end each have the shape resembling a fusion of a semicircle with a rectangle and each have three straight edge portions and a semicircular arc-shaped edge portion. The central light entry surface 82 has the shape of a rectangle. The light entry surfaces 72, 82, 92 are arranged such that together they form a rectangular strip with rounded-off ends.

No interspaces between the light entry surfaces 72, 82, 92 are present in the idealized embodiment shown in FIG. 7. However, only small interspaces between the light entry surfaces 72, 82, 92 are also realizable in a similar real embodiment that can be obtained with comparatively little technical outlay. Hence, less illumination light is lost in comparison with the embodiment illustrated in FIG. 7, and the proximal ends of the light transfer devices 70, 80, 90 and the surroundings thereof are heated less.

FIG. 9 shows a schematic illustration of a section through a further embodiment of the endoscope 10 from FIG. 1, which in terms of a few features, properties and functions is similar to the embodiments illustrated in FIGS. 2 and 6. The type of illustration, the pose and the orientation of the plane of the drawing correspond to those in FIGS. 2 and 6. In particular, features, properties and functions whereby the embodiment shown in FIG. 9 differs from the embodiment illustrated in FIG. 6 are described below.

Like in the embodiment depicted in FIG. 6, the light entry surfaces 72, 82, 92 of the light transfer devices 70, 80, 90 are arranged next to one another in a plane. The shape and arrangement of the light entry surfaces 72, 82, 92 of the light transfer devices 70, 80, 90 for example correspond to that of FIG. 7 or FIG. 8.

Like in the embodiment illustrated in FIG. 2, a fiber cone 30 is provided; however, it is not movable. A translationally movable mirror 50 is provided in the proximal end region 12 of the endoscope 10. A first collimator 52 that is stationary relative to the endoscope 10 is arranged at approximately the distance of its focal length from the light exit surface 36 of the fiber cone 30. A second collimator 54 that is movable together with the mirror 50 is arranged at approximately the distance of its focal length from the light entry surfaces 72, 82, 92 of the light transfer devices 70, 80, 90.

The mirror 50 and the second collimator 54 are fastened in a predetermined arrangement and orientation relative to one another on a slider 56. In FIG. 9, an arrow indicates that the slider 56 is translationally movable. A linear guide (not illustrated here) allows a movement of the slider 56 along a predetermined and, in particular, straight path and suppresses all other movements. A first end of a lever 58 is arranged outside of the housing of the endoscope 10 and is manually actuatable or pivotable. A second end of the lever 58 is mechanically coupled to the slider 56, and so a pivot movement of the lever 58, which is indicated in FIG. 9 by a circular arc-shaped arrow, is accompanied by a translational movement of the slider 56, which is indicated in FIG. 9 by a straight arrow.

Divergent illumination light emanating from the light exit surface 36 of the fiber cone 30 propagates substantially in a parallel beam with at best little divergence or convergence downstream of the stationary first collimator 52. The collimated light is incident on the mirror 50 and is steered by the latter to the second collimator 54. The second collimator focuses the illumination light on one or more of the light entry surfaces 72, 82, 92 of the light transfer devices 70, 80, 90.

The lever 58 forms a drive device for the slider 56. Together with the mirror 50 and the second collimator 54, the slider 56 forms a controllable input coupling device. The slider 56 with the mirror 50 and the second collimator 54 can be moved by manual actuation of the lever 58. This allows selection of the light transfer device 70, 80, 90 into which illumination light is input coupled and of the direction a, b, d into which illumination light is transmitted.

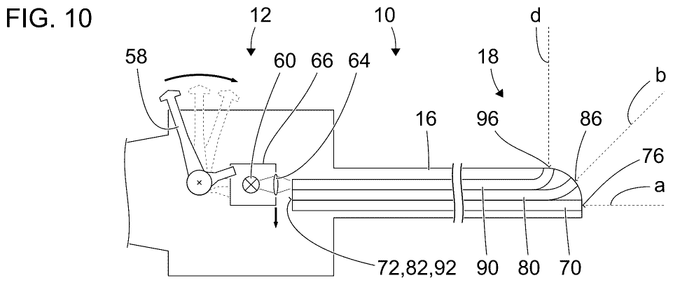

FIG. 10 shows a schematic illustration of a section through a further embodiment of the endoscope 10 from FIG. 1, which in terms of a few features, properties and functions is similar to the embodiments illustrated in FIGS. 2, 6 and 9. The type of illustration, the pose and the orientation of the plane of the drawing correspond to those in FIGS. 2, 6 and 9. In particular, features, properties and functions whereby the embodiment shown in FIG. 10 differs from the embodiments illustrated in FIGS. 6, 5 and 9 are described below.

Like in the embodiments depicted in FIGS. 6 and 9, the light entry surfaces 72, 82, 92 of the light transfer devices 70, 80, 90 are arranged next to one another in a plane. The shape and arrangement of the light entry surfaces 72, 82, 92 of the light transfer devices 70, 80, 90 for example correspond to that of FIG. 7 or FIG. 8.

Unlike in the embodiments illustrated in FIGS. 2, 6 and 9, the endoscope 10 does not comprise a light coupling. Instead, a light source 60 is provided in the proximal end region 12 of the endoscope 10. The light source 60 and a lens 64 are fastened to a translationally movable slider 66. In FIG. 10, an arrow indicates that the slider 66 is translationally movable. A linear guide (not illustrated here) allows a movement of the slider 66 along a predetermined and, in particular, straight path and suppresses all other movements. A first end of a lever 58 is arranged outside of the housing of the endoscope 10 and is manually actuatable or pivotable. A second end of the lever 58 is mechanically coupled to the slider 66, and so a pivot movement of the lever 58, which is indicated in FIG. 10 by a circular arc-shaped arrow, is accompanied by a translational movement of the slider 66, which is indicated in FIG. 10 by a straight arrow.

Divergent illumination light emanating from the light source 60 is focused by the lens 64.

The lever 58 forms a drive device for the slider 66. Together with the light source 60 and the lens 64, the slider 66 forms a controllable input coupling device. The slider 66 with the light source 60 and the lens 64 can be moved by manual actuation of the lever 58. This allows selection of the light transfer device 70, 80, 90 into which illumination light created by the light source 60 is input coupled and of the direction a, b, d into which illumination light is transmitted.

### REFERENCE SIGNS

10 Endoscope
12 Proximal end region of the endoscope 10
14 Light coupling at the proximal end region 12 of the endoscope 10
16 Shaft of the endoscope 10
18 Distal end region of the endoscope 10
20 Light guide cable
22 Handwheel for manual control of the viewing direction and the illumination direction of the endoscope 10
24 Magnet on the handwheel
26 Magnet within a hermetically sealed cover of the endoscope 10
28 Mounting for fiber cone 30
30 Fiber cone
32 Light entry surface of the fiber cone 30
36 Light exit surface of the fiber cone 30
38 Axis of rotation of the fiber cone 30
40 Light guide device in the proximal end 12 of the endoscope 10
42 Light entry surface of the light guide device 42
46 Movable light exit surface of the light guide device 42
50 Mirror
52 Stationary first collimator
54 Movable second collimator
56 Translationally movable slider, to which the mirror 50 and the movable collimator 54 are fastened
58 Lever
60 Light source for creating illumination light at the proximal end of the endoscope 10
64 Lens for bundling the illumination light created by the light source 60
66 Translationally movable slider, to which the light source 60 and the lens 64 are fastened
70 First light transfer device for transferring illumination light from the proximal end 12 to the distal end 18 of the endoscope 10
72 Light entry surface of the first light transfer device 70
76 Light exit surface of the first light transfer device 70
80 Second light transfer device for transferring illumination light from the proximal end 12 to the distal end 18 of the endoscope 10
82 Light entry surface of the second light transfer device 80
86 Light exit surface of the second light transfer device 80
90 Third light transfer device for transferring illumination light from the proximal end 12 to the distal end 18 of the endoscope 10
92 Light entry surface of the third light transfer device 90
96 Light exit surface of the third light transfer device 90
a First viewing direction
A First field of view
b Second viewing direction
B Second field of view
d Third viewing direction
D Third field of view

1. A light control device for controlling the illumination direction for an optical instrument, having a plurality of light transfer devices, with each light transfer device comprising a light entry surface and at least one light exit surface and being provided and designed to transfer illumination light from the light entry surface to the at least one light exit surface and with illumination light that was input coupled into the light entry surfaces exiting in different illumination directions through light exit surfaces of different light transfer devices; a controllable input coupling device for controllably input coupling illumination light, which is created by a light source, into the light entry surface of at least one selectable light transfer device.

2. The light control device of claim 1, further comprising a drive device for moving at least one piece of the controllable input coupling device.

3. The light control device of claim 2, wherein the drive device comprises an actuation device which is directly manually actuatable and directly or indirectly coupled in mechanical or magnetic fashion with the controllable input coupling device.

4. The light control device of claim 2, wherein the drive device comprises an electric motor.

5. The light control device of claim 1, wherein the controllable input coupling device comprises a light guide device having a light entry surface and a light exit surface, at least the light guide device or the light entry surface of the light guide device or the light exit surface of the light guide device or the light entry surface of at least one light transfer device being translatable or rotatable or pivotable in such a way that the light exit surface of the light guide device is arranged vis-à-vis the light entry surface of at least one selectable light transfer device or rests against said light entry surface.

6. The light control device of claim 1, wherein the controllable input coupling device comprises a fiber cone having a light entry surface and a light exit surface, at least the fiber cone or the light entry surface of at least one light transfer device being rotatable or pivotable in such a way that the light exit surface of the fiber cone is arranged vis-à-vis the light entry surface of at least one selectable light transfer device or rests against said light entry surface.

7. The light control device of claim 6, wherein the fiber cone is rotatable about an axis of rotation orthogonal to the light entry surface of the fiber cone; the light exit surface of the fiber cone is not symmetrical with respect to the axis of rotation.

8. The light control device of claim 1, wherein the controllable input coupling device is provided and designed to at least translationally move or pivot or rotate a light source.

9. An optical instrument having a light control device for controlling the illumination direction for the optical instrument, the light control device having a plurality of light transfer devices, with each light transfer device comprising a light entry surface and at least one light exit surface and being provided and designed to transfer illumination light from the light entry surface to the at least one light exit surface and with illumination light that was input coupled into the light entry surfaces exiting in different illumination directions through light exit surfaces of different light transfer devices; a controllable input coupling device for controllably input coupling illumination light, which is created by a light source, into the light entry surface of at least one selectable light transfer device.

10. The optical instrument of claim 9, having a proximal end region, at which the optical instrument can be fastened or manually guided during intended use; a distal end region, at which the light exit surfaces of the light transfer devices of the light control device are arranged, with the controllable input coupling device being arranged in the proximal end region of the optical instrument.

11. The optical instrument claim 9, further comprising: a controllable viewing direction device for controlling the viewing direction of the optical instrument, with the controllable input coupling device being coupled with the controllable viewing direction device.

12. The optical instrument claim 10, further comprising: a controllable viewing direction device for controlling the viewing direction of the optical instrument, with the controllable input coupling device being coupled with the controllable viewing direction device.

13. The optical instrument of claim 9, further comprising a light coupling situated at the proximal end region of the optical instrument and serving for mechanical and optical coupling of a light guide cable with the optical instrument, with the controllable input coupling device being arranged on or in the light coupling.

14. The optical instrument of claim 10, further comprising a light coupling situated at the proximal end region of the optical instrument and serving for mechanical and optical coupling of a light guide cable with the optical instrument, with the controllable input coupling device being arranged on or in the light coupling.

15. The optical instrument of claim 11, further comprising a light coupling situated at the proximal end region of the optical instrument and serving for mechanical and optical coupling of a light guide cable with the optical instrument, with the controllable input coupling device being arranged on or in the light coupling.

16. The optical instrument of claim 12, further comprising a light coupling situated at the proximal end region of the optical instrument and serving for mechanical and optical coupling of a light guide cable with the optical instrument, with the controllable input coupling device being arranged on or in the light coupling.

17. The optical instrument of claim 13, further comprising a light coupling situated at the proximal end region of the optical instrument and serving for mechanical and optical coupling of a light guide cable with the optical instrument, with the controllable input coupling device being arranged on or in the light coupling.

18. The optical instrument of claim 9, wherein the light control device further comprises a drive device for moving at least one piece of the controllable input coupling device.

19. The optical instrument of claim 18, wherein the light control device further comprises an actuation device which is directly manually actuatable and directly or indirectly coupled in mechanical or magnetic fashion with the controllable input coupling device.

20. The optical instrument of claim 9, wherein the controllable input coupling device comprises a light guide device having a light entry surface and a light exit surface, at least the light guide device or the light entry surface of the light guide device or the light exit surface of the light guide device or the light entry surface of at least one light transfer device being translatable or rotatable or pivotable in such a way that the light exit surface of the light guide device is arranged vis-à-vis the light entry surface of at least one selectable light transfer device or rests against said light entry surface
